(19) United States
(12) Patent Application Publication
(10) Pub. No.: US 2011/0133438 A1
(43) Pub. Date: Jun. 9, 2011

(54) Utility Vehicle Module

(76) Inventors: Christopher A. Haines, Dana Point, CA (US); Paul T. Wilkins, Santa Ana, CA (US)

(21) Appl. No.: 12/634,592

(22) Filed: Dec. 9, 2009

(51) Int. Cl. B60R 9/06

(52) U.S. Cl. 280/769

(57) ABSTRACT

A rack for an all terrain vehicle is disclosed. The rack is attached to the roll cage of the all terrain vehicle as well as a frame of the all terrain vehicle. In particular, the rack may have one or more parts that permit movement of the rack to mitigate failure as the all terrain vehicle traverses over uneven terrain.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a rack that can be used to mount various components such as a tire carrier, fluid container carrier, stretcher, etc. to an all terrain vehicle and/or a utility terrain vehicle.

All terrain vehicles (“ATVs”) and utility terrain vehicles (“UTVs”), collectively referred to hereinafter as ATVs are four wheel drive vehicles that traverse over uneven terrain including but not limited to rocks, tree stumps, etc. Typically, these ATVs are subjected to substantial abuse, vibration, jolts and other shaking forces. Examples of an ATV is a Ranger 800 XP sold by Polaris and a Teryx sold by Kawasaki. Other brands and models of ATVs are also contemplated. These ATVs are designed for extended heavy duty use. The rear of the ATV may have a bed for carrying various objects. Unfortunately, the bed may have limited utility since the ATV may be very bumpy as it is traversing over uneven terrain. The objects within the bed may bounce out of the bed. Tie downs and various other latching mechanisms may be supplied. Nonetheless, these tie downs and latching mechanisms are limited in use and provide only marginally improved loading capabilities.

Accordingly, there is a need in the art for improving the ability of ATVs to carry more components or objects despite rugged use of the ATV.

### BRIEF SUMMARY

The rack disclosed herein addresses the needs discussed above, discussed below and those that are known in the art.

The rack may comprise left and right upper frame members that can be slid into left and right brackets mounted to a roll cage of the ATV. A lower frame member may be attached to a bottom side of a frame of the ATV and may be slid into the left and right upper frame members. The left and right upper frame members may be attached to the left and right brackets as well as the lower frame member by way of a nut and bolt connection. More particularly, corresponding holes may be formed in the left and right upper frame members, left and right brackets, and the lower frame such that the bolts pin the rack together upon assembly. The holes may be oversized with respect to the bolt such that the left and right upper frame members may provide slack (e.g., wiggle, slide in and out or move side to side) as the ATV traverses over uneven terrain. The slight movement allowed by the left and right upper frame members mitigate stress concentrations and failure of the rack during extended rugged use.

The rack may further comprise one or more mounting holes that can be used to mount components to the rack. The components may be a tire carrier, a tray, a fluid container carrier, a stretcher, etc.

Due to the sliding attachment points, the rack may be mounted to the ATV by one person.

More particularly, a rack mountable to an ATV having a rear suspension with upper and lower A-arm mounts and a roll cage is disclosed. The rack may comprise left and right upper brackets attached to the roll cage. Left and right upper frame members with upper distal end portions may be moveably attached to the left and right upper brackets for mitigating failure of the attachment between the upper distal end portions of the left and right upper frame members and the left and right upper brackets. Left and right lower frame members defining upper distal end portions may be moveably attached to the lower distal end portions of the left and right upper frame members for mitigating failure of the attachment between the lower distal end portions of the left and right upper frame members and the upper distal end portions of the left and right lower frame members. Lower distal end portions of the left and right lower frame members may be attached to one or both of the upper and lower A-arm mounts.

The attachments may be bolted together for facilitating field repair, replacement and cannibalization.

One of the distal end portions of the left and right upper frame members and the left and right upper brackets are slideably disposable within the other one of the distal end portions of the left and right upper frame members and the left and right upper brackets for mitigating failure.

For example, the left and right upper brackets may be tubes and the distal end portions of the left and right upper frame members may be tubes that slide within the tubes of the left and right upper brackets for mitigating failure. The rack may further comprise pins (e.g., nut and bolt connection, pin and cotter pin, etc.) that engage both the tubes of the distal end portions of the left and right upper frame members and the tubes of the left and right upper brackets for preventing pull out of the left and right upper frame members from the left and right upper brackets.

The tubes of the left and right upper brackets and the tubes of the distal end portions of the left and right upper frame members may have corresponding holes sized and configured to receive the pins. The holes formed in the tubes of the distal end portions of the left and right upper frame members may be oversized compared to the pin to permit movement and mitigate failure.

One of the lower distal end portions of the left and right upper frame members and the upper distal end portions of the left and right lower brackets may be slideably disposed within the other one of the distal end portions of the left and right upper frame members and the upper distal end portions of the left and right lower brackets for mitigating failure.

For example, the upper distal end portions of the left and right lower frame members may be tubes that slide within tubes of the lower distal end portions of the left and right upper frame members for mitigating failure. The rack may further comprise pins (e.g., nut and bolt connection, pin and cotter pin, etc.) that engage both the tubes of the lower distal end portions of the left and right upper frame members and the tubes of the left and right lower frame members for preventing pull out of the left and right upper frame members from the left and right lower frame members.

The tubes of the upper distal end portions of the left and right lower frame members and the tubes of the lower distal end portions of the left and right upper frame members may have holes for receiving the pins. The holes formed in the upper distal end portions of the left and right lower frame members may be oversized compared to the pin to permit movement and mitigate failure.

A rear bumper may be attached to the left and right lower frame members. The left and right upper frame members and the rear bumper may include one or more standard mounting holes to allow one or more components to be selectively mounted to sides and rear of the rack.

The mounting component may be a means for carrying a tire on the rack, a means for carrying a fluid container on the rack, a means for carrying a stretcher on the rack or a tray.

The rack may further comprise one or more tie downs attached to the left and right upper frame members, left and right lower frame members and/or the rear bumper.

Additionally, an adaptable rear mounted rack system for an all terrain vehicle having a chassis is disclosed. The rack system may comprise a frame and a plurality of upper mounts. The frame may define an upper portion and a lower portion. The upper portion of the frame may be attachable to a roll cage of the all terrain vehicle and the lower portion may be attachable to a rear portion of the chassis of the all terrain vehicle for mounting the frame to the rear of the all terrain vehicle. The plurality of upper mounts may be attached to the upper portion of the frame to enable selective attachment of different mounting brackets to the upper portion of the frame for adapting the rack system as needed. Also, a plurality of lower mounts may be attached to the lower portion of the frame to enable selective attachment of different mounting brackets to the lower portion of the frame for adapting the rack system as needed. The mounting bracket may be one or more of a tire carrier bracket, a tray bracket, a fluid container carrier bracket and a stretcher bracket.

Each of the upper and lower mounts may define a through hole axis generally parallel to each other. Each of the upper and lower mounts may define a flat surface generally perpendicular to the through hole axis.

The upper portion of the frame may define upper left and right frame members and the lower portion of the frame may define a rear bumper with the upper and lower mounts attached to the upper left and right frame members and the rear bumper. The lower portion of the frame may be attached to one or both of upper and lower A-arm mounts of the chassis of the all terrain vehicle. More generally, the lower portion of the frame may be attached to a rear section of the chassis of the all terrain vehicle.

A method of mounting a rack to an ATV so that the rack is mountable to the ATV by one person is also disclosed. The method may comprise the steps of loosely attaching left and right brackets to a roll cage of the ATV; loosely attaching left and right upper frame members to the left and right brackets; loosely attaching left and right lower frame members to at least one of two A-arm mounts of the ATV suspension; loosely attaching the left and right upper frame members to the left and right lower frame members; and after performing all of the loosely attaching steps, tightening down all of the loose attachments.

The loosely attaching left and right upper frame members to the left and right brackets step may comprise the step of sliding distal end portions of the left and right upper frame members to tubes of the left and right brackets.

The method may further comprise the step of providing oversized holes in the distal end portions of the left and right upper frame members compared to pins which are used to attach the left and right upper frame members to the left and right brackets.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a rack mounted to an all terrain vehicle;

FIG. 2 is an enlarged exploded perspective view of an upper frame member telescoped into a bracket;

FIG. 3 is an exploded perspective view of a tube attached to a rear bumper of a lower frame member telescoping into the upper frame member;

FIG. 4 is an exploded perspective view of the lower frame member of the rack attached to an A-arm mount of the all terrain vehicle;

FIG. 5 is a rear view of the rack and all terrain vehicle shown in FIG. 1;

FIG. 5A is an alternate embodiment for attaching the lower frame to the A-arm mount of the all terrain vehicle;

FIG. 6 illustrates a tire carrier selectively attachable to one or more mounting holes;

FIG. 7 illustrates an embodiment of a fluid container carrier attachable to the rack and two embodiments of a tray attachable to the rack;

FIG. 7A is an enlarged view of FIG. 7 illustrating a fluid container carrier;

FIG. 8 is an exploded perspective view of one of the embodiments of the tray attached to the rack and a partial view of the fluid container carrier shown in FIG. 7;

FIG. 9 is an exploded perspective view illustrating a second embodiment of a fluid container carrier that may be attached to the tire carrier or a tire that may be attached to the tire carrier;

FIG. 10 illustrates a stretcher that may be attached to the rack;

FIG. 11 illustrates the right shoulder harness shown in FIG. 2 for a four or five point seat belt; and

FIG. 12 illustrates a front view of the four or five point seat belt shown in FIG. 11.

### DETAILED DESCRIPTION

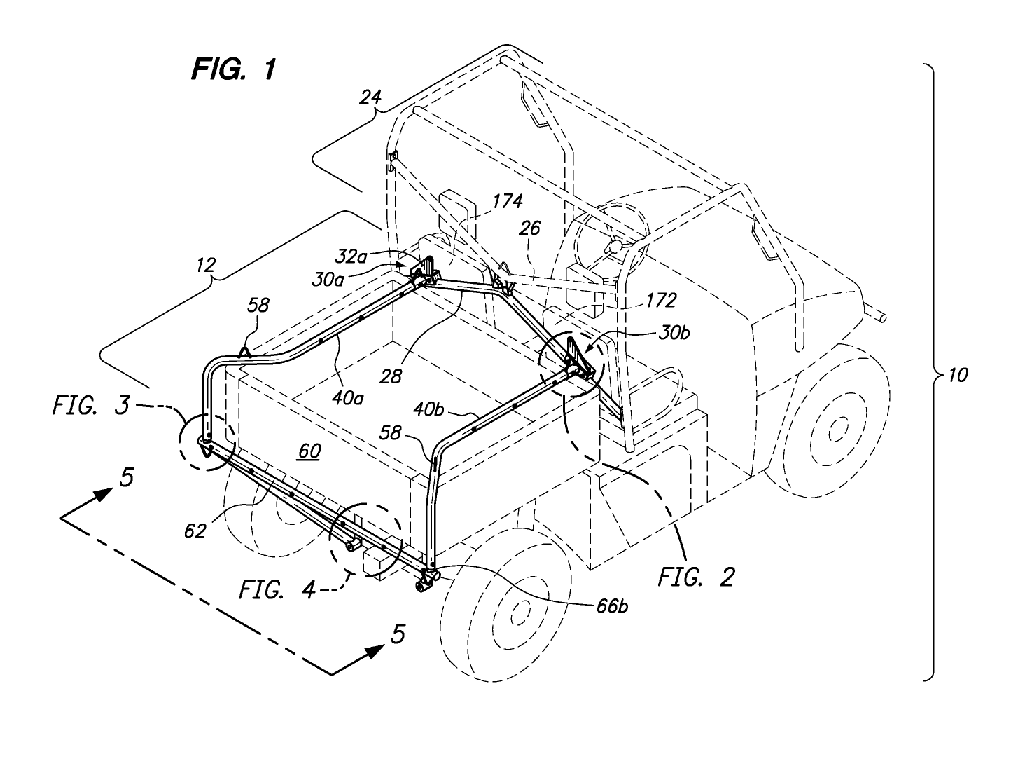

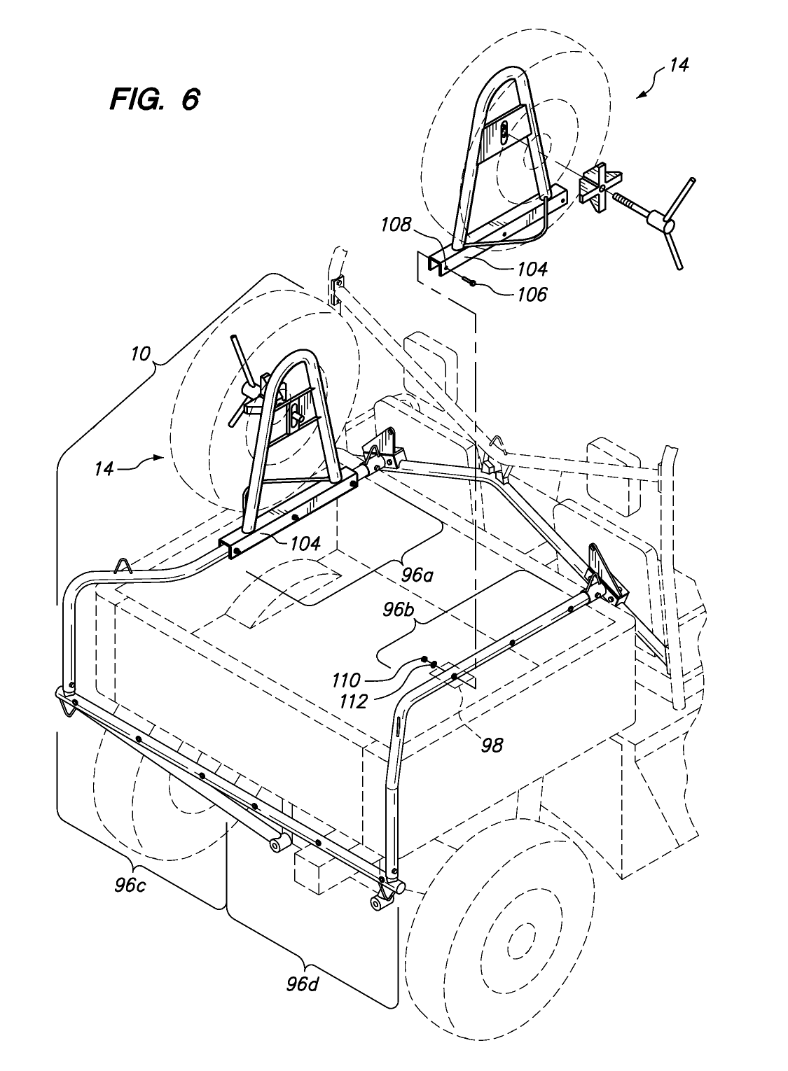

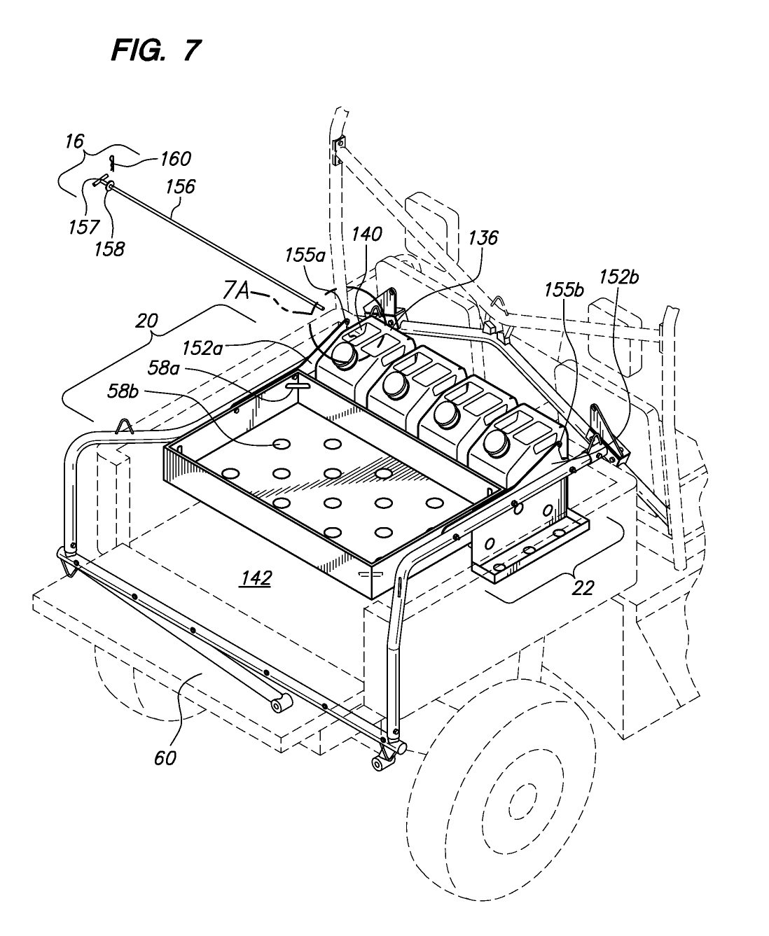

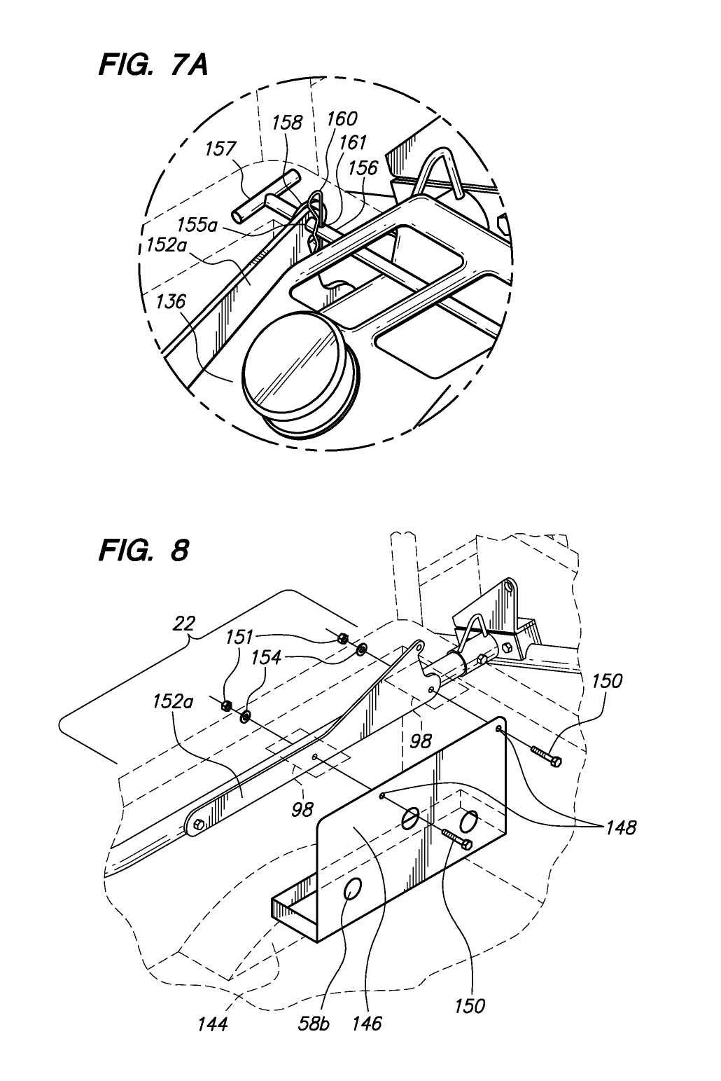

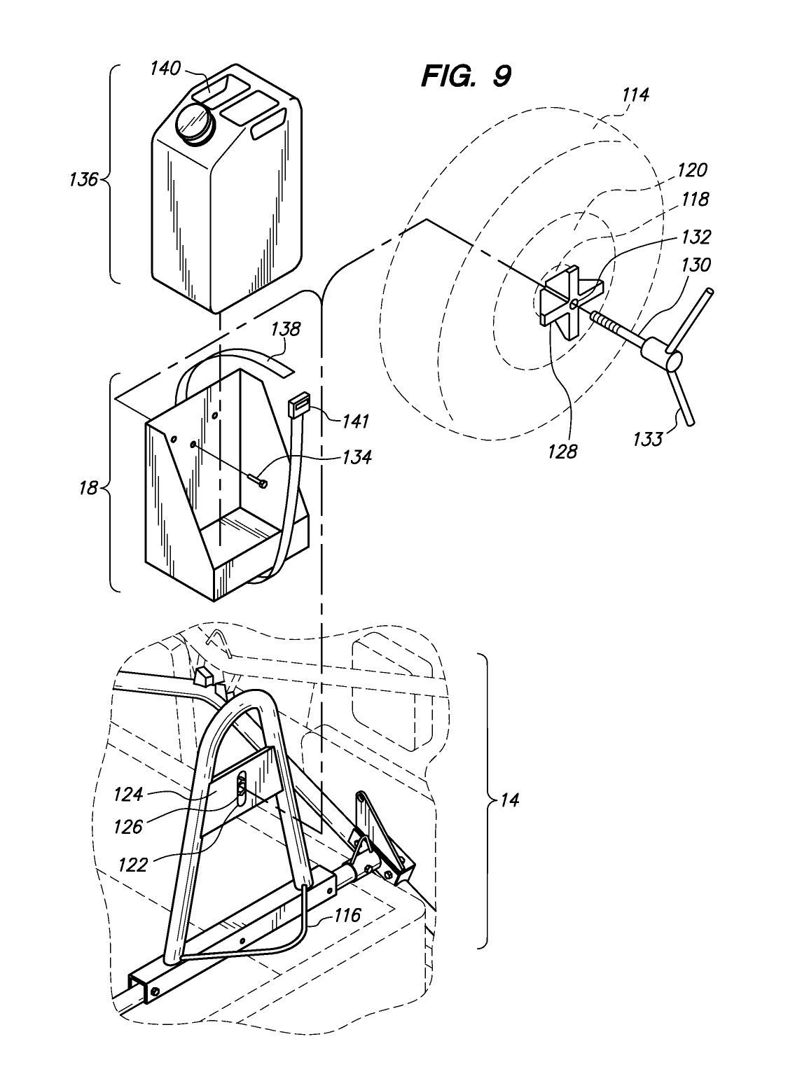

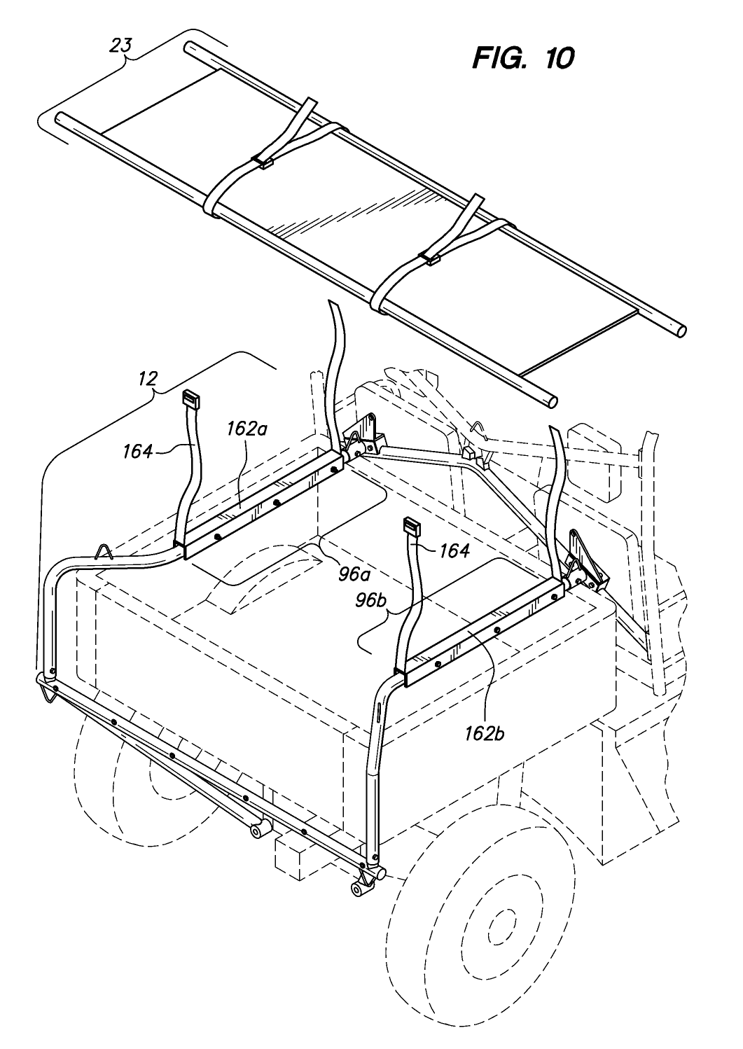

Referring now to FIG. 1, an ATV 10 is shown. A rack 12 mounted to the rear of the ATV 10 for the purposes of carrying other components is disclosed. The other components may include a tire carrier 14 (see FIG. 6), fluid container carriers 16, 18 (see FIGS. 7 and 9), trays 20, 22 (see FIGS. 7 and 8), stretcher 24 (see FIG. 10) and small arms to rocket launcher, rifle mount, etc. The ATV 10 may be a four wheel drive vehicle that may be driven over bumpy terrain (e.g., rocks, tree stumps, etc.). As a result, the frame of the ATV 10 bends, twists and contorts. The awkward stresses imposed on the ATV 10 impose stress concentrations on the rack 12. To mitigate fracture of the rack 12, the same is fabricated to have a moveable (e.g., sliding, slack, etc.) construction as will be discussed further below to accommodate the bending, twisting of the frame of the ATV 10.

The rack 12 may also have a bolt on construction such that various good parts of a damaged rack 12 may be cannibalized from other damaged racks 12 during field use. No welding of other fabrication is required for assembly. Additionally, the rack 12 may be mounted to the ATV 10 by a single person so that the person can maintain the rack 12 during field use.

More particularly, the rack 12 may be mounted to a roll cage 24 of the ATV 10 as shown in FIG. 1. The roll cage 24 shown in FIG. 1 has an upper cross brace 26 and a lower cross brace 28. The lower cross brace 28 may be modified so as to have left and right brackets 30a, b for mounting the rack 12 to the roll cage 24. Alternatively, the lower cross brace 28 may be entirely replaced with a new lower cross brace fabricated from a stiffer, more durable material or enlarged to provide for the additional stiffness and durability. The new lower cross brace 28 may be fabricated with the left and right brackets 30a, b. The new lower cross brace 28 fits under the upper cross brace 26 and is mounted in the same manner as the original lower cross brace 28. Although a particular type of upper and lower cross braces 26, 28 are shown, it is contemplated that the rack 12 may be mounted to any other type of ATV 10 having a different setup for the roll cage 24. Additionally, the rack 12 may be mounted to a two wheel drive vehicle and a vehicle without a roll cage 24 as long as mounting points (e.g., left and right brackets 30a, b) are provided.

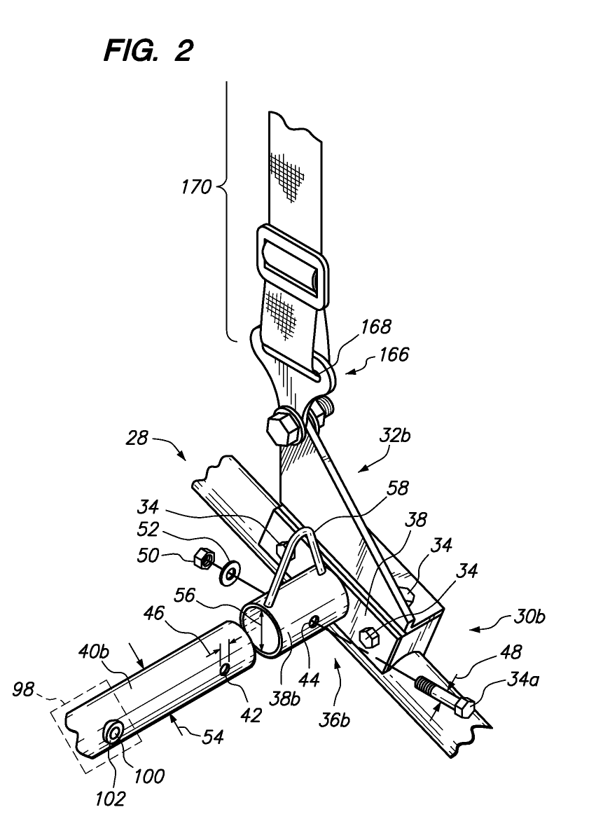

Referring now to FIG. 2, the right bracket 30b is shown. The left brackets 30a may have a minor configuration and all of the same characteristics as the right bracket 30b. However, for the purposes of clarity, the right bracket 30b will be discussed. The right bracket 30b may be welded to the lower cross brace 28. A right shoulder harness 32b may be attached to the right bracket 30b with one or more bolts 34. Also, a right tubular mount 36b may be attached to the right bracket 30b by way of one or more bolts 34. The right tubular mount 36b may have a flat plate 38 with one or more holes. The bolts 34 are threaded into the holes and bolted to the right bracket 30b. A right tube 38b may have attached to the flat plate 38 and protrude rearwardly from the roll cage 24 (see FIG. 1). An upper right frame member 40b (see FIGS. 1 and 2) may be slid into the right tube 38b and may have some slack to permit the upper right frame member 40b to move (e.g., wiggle, slide in and out and/or side to side, etc.) within the right tube 38b during use to mitigate failure. To attach the upper right frame member 40b to the right tube 38b, corresponding holes 42, 44 may be formed in the upper right frame member 40b and right tube 38b. An inner diameter 46 of the holes 42 formed in the upper right frame member 40b may be oversized with respect to an outer diameter 48 of bolt 34a (see FIG. 2). The bolt 34 is passed through the holes 42, 44 after the upper right frame member 40b is slid into the right tube 38b and bolted on with a nut and washer 50, 52. Since the inner diameter 46 of the hole 42 is oversized with respect to the outer diameter 48 of the bolt 44a and/or the outer diameter 54 is undersized with respect to the inner diameter 56 of the right tube 38b, as the ATV 10 is driven over rocks, tree stumps, etc. the rack 12 allows for movements to relieve stress and prevent stress concentration that would promote fractures and breakage of the rack 12 during field use. The moveable nature of the upper right frame member 40b with respect to the right tube 38b and the permitted movement (e.g., wiggling, sliding in and out, side to side, etc.) between these two components 40b, 38b aid in the reduction of stress concentration within acceptable limits to mitigate failure of the rack 12 during field use. The inner peripheries of the holes 42, 44 may be deburred, rounded, etc. to mitigate stress concentrations and failures.

The right tube 38b and the upper right frame member 40b are shown as having a cylindrical or circular configuration. However, other configurations are also contemplated. By way of example and not limitation, the right tube 38b and the upper right frame member 40b may have a square configuration, a triangular configuration or any other configuration. Additionally, the upper right frame member 40b is shown as being inserted into the right tube 38b. However, the reverse situation is also contemplated, specifically, the right tube 38b may be slid into the upper right frame member 40b. In this instance, the tie down 58 may be removed from the right tube 38b or the right tube 38b may be elongated to permit such insertion. Additionally, the hole 44 may then be oversized with respect to the outer diameter 48 of the bolt 34a to permit movement of the upper right frame member 40b and the right tube 38b. It is additionally contemplated that both the holes 42 and 44 may be oversized with respect to the outer diameter 48 of the bolt 34a to permit movement between the upper right frame member 40b and the right tube 38b to relieve stress concentrations.

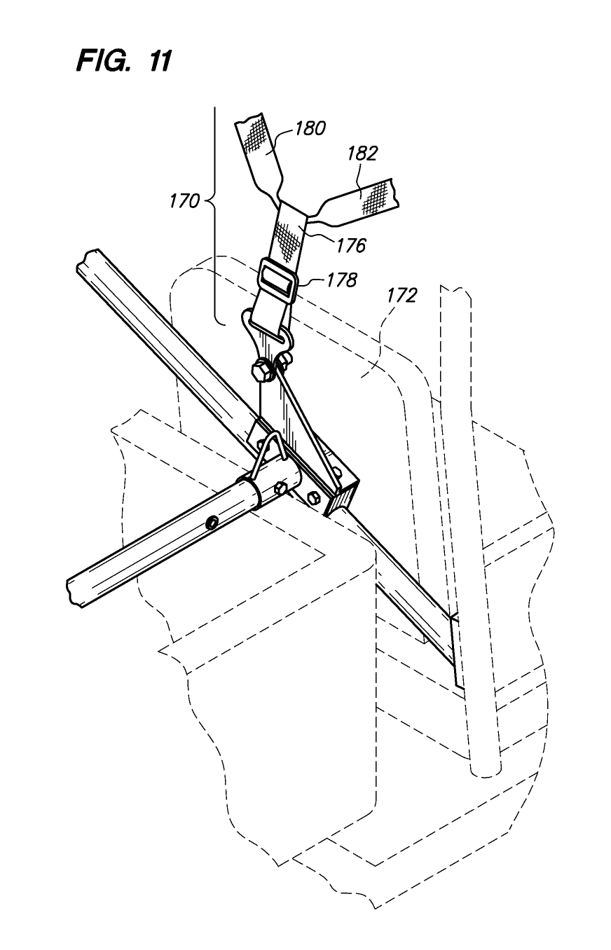

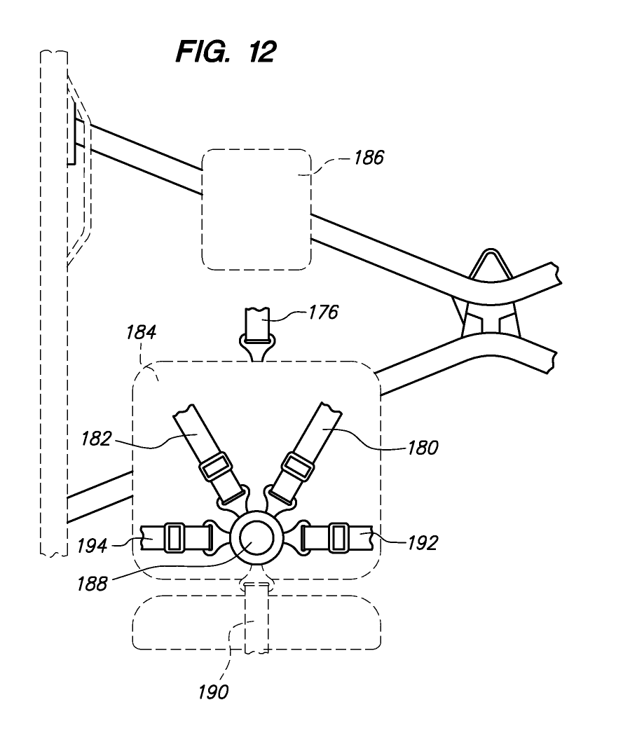

The right shoulder harness 32b is attached to the right bracket 30b and allows the ATV 10 having a three point seatbelt harness to be adapted to have a four or five point seatbelt harness. Similarly, a left shoulder harness may be attached to the left bracket 30a and allows the ATV 10 having a three point seatbelt harness to be adapted to have a four or five point seatbelt harness. This will be discussed below in relation to FIGS. 11 and 12.

Referring back to FIG. 1, the upper left frame member 40a may be attached to the left bracket 30a in the same manner as described above in relation to the right side of the rack 12. Additionally, a left shoulder harness 32a may be attached to the left bracket 30a as discussed above in relation to the right shoulder harness 32b.

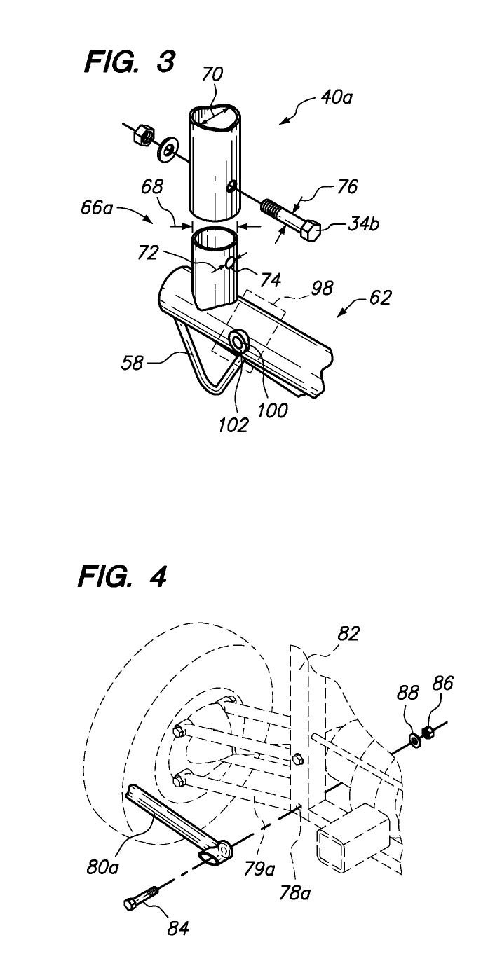

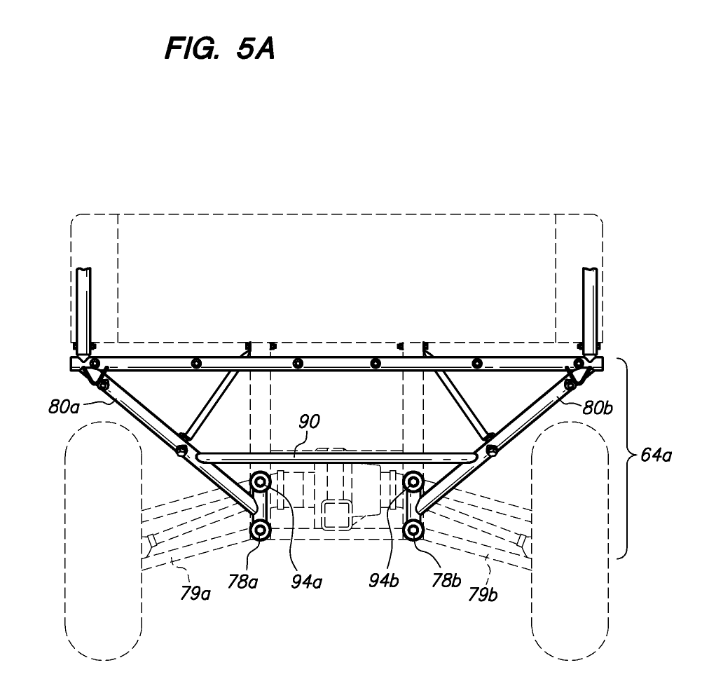

As shown in FIG. 1, the upper left and right frame members 40a, b extend rearwardly from the roll cage 24 and are generally parallel to each other. Prior to reaching a tailgate 60 of the ATV 10, the upper left and right frame members 40a, b are splayed outwardly. This permits the tailgate 60 to be opened and closed (see FIGS. 1 and 7). The upper left and right frame members 40a, b then proceeds downwardly toward a rear bumper 62 which may be part of a lower frame 64 (see FIG. 5). The distal end portions of the upper left and right frame members 40a, b may be attached to the rear bumper 62 in a sliding fashion similar to the attachment of the upper left and right frame members 40a, b to the left and right brackets 30a, b as discussed above. More particularly, referring now to FIG. 3, a partial section of the upper left frame member 40a and rear bumper 62 are shown. The upper left frame member 40a may be bolted to a lower left tube 66a in the following manner. The lower left tube 66a may be welded to the rear bumper 62. An outer diameter 68 of the lower left tube 66a may be smaller than an inner diameter 70 of the upper left frame member 40a. In this manner, the lower left tube 66a may slide into the upper left frame member 40a. An inner diameter 72 of a hole 74 formed in the lower left tube 66a may be oversized with respect to an outer diameter 76 of bolt 34b which may be used to pin both the upper left frame 40a and the lower left tube 66a together. (See FIG. 3). The lower left tube 66a may move (e.g., wiggle, slide in and out, side to side, etc.) within the upper left frame member 40a due to the oversized inner diameter 72 of the hole 74 with respect to the outer diameter 76 of the bolt 34b. As the ATV 10 maneuvers over rocks, wood stumps, etc., the frame of the ATV 10 may bend and twist. The slack provided by the upper left and right frame members 40a, b to the left and right brackets 30a, b as well as the left and right lower tubes 66a, b (see FIGS. 1 and 3) mitigates stress concentration within the rack 12 to within an acceptable limit to prevent failure of the rack 12 during field use.

The upper left frame member 40a and the lower left tube 66a are shown as having a cylindrical or circular configuration. However, other configurations are also contemplated. By way of example and not limitation, the upper left and right frame members 40a, b and the lower left and right tubes 66a, b may have a square configuration, triangular configuration or any other configuration. Additionally, the lower left and right tubes 66a, b are shown and described as sliding into upper left and right frame members 40a, b. However, the reverse situation is also contemplated, specifically, the left and right upper frame members 40a, b may be slid into the lower left and right tubes 66a, b. In this situation, the hole formed in the left and right upper frame members 40a, b may be oversized with respect to the outer diameter 76 of the bolt 34b. It is additionally contemplated that both the holes 74 formed in the left and right tubes 66a, b and the holes formed in the upper left and right frame members 40a, b may be oversized with respect to the outer diameter 76 of the bolt 34b to permit movement and mitigate failure regardless of which part slides into the other.

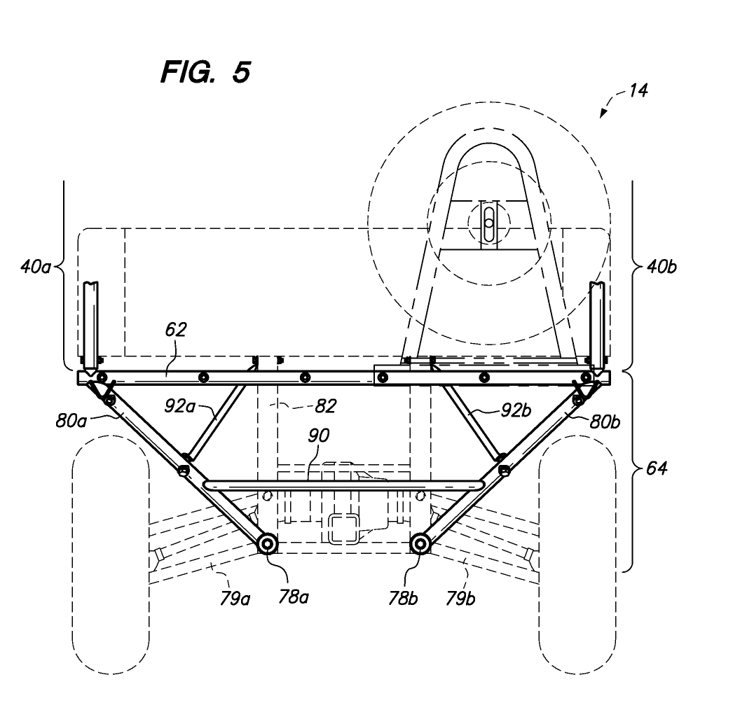

Referring now to FIGS. 1, 4 and 5, the lower frame 64 (see FIG. 5) may be attached to the upper left and right frame members 40a, b as discussed above. Additionally, the lower frame 64 may be attached to left and right lower A-arm mounts 78a, b. This provides increased strength. In particular, left and right down tubes 80a, b may be attached to opposed distal end portions of the rear bumper 62. A bolt attaching the lower A-arm 79a to a frame 82 of the ATV 10 may be removed. As shown in FIG. 4, a slightly longer bolt 84 may be used to bolt the left down tube 80a to the lower left A-arm mount 78a. Bolt 84 may be attached to the frame 82 with nut 86 and washer 88. Although not shown, a bolt 84 may be used to bolt the right down tube 80b to the lower right A-arm mount 78b. The bolt 84 may be attached to the frame 82 with nut 86 and washer 88. Although the description and the drawings show the lower frame 64 attached to A-arm mounts 78a,b, it is also contemplated that the lower frame 64 may be attached to the A arm or the rear of the chassis.

The left and right down tubes 80a, b may be attached to each other by the bumper 62 as well as a crossbar 90 (see FIG. 5) to form a generally rigid lower frame 64. The generally rigid lower frame 64 and the separate left and right upper frame members 40a, b aid in mitigating failure yet providing sufficient rigidity to the rack 12. The lower frame 64 may be additionally braced to the frame 82 of the ATV 10 by way of lower left and right braces 92a, b. The left and right braces 92a, b may be bolted to the left and right down tubes 80a, b as well as the frame 82 as shown in FIG. 5. Referring now to FIG. 5A, alternate lower frame 64a is shown. The left and right down tubes 80a, b are attached to both upper and lower A-arm mounts 94a, b and 78a, b with a nut and bolt connection.

The rack 12 may have an entirely bolt-on mounting system for assembly purposes although a welded assembly is also contemplated. When a fleet of ATVs 10 is deployed in the field, one or more of the racks of the vehicles may be destroyed. The good components of the destroyed racks 12 may be cannibalized and used on other racks. This cannibalization is permitted due to the bolt-on mounting system of the rack 12. During field use when new components or components cannot be ordered, cannibalization of good parts of a damaged rack 12 may provide the means of rebuilding salvageable racks.

The rack 12 may additionally be mounted to the ATV 10 by one person. In particular, the lower frame 64, 64a may initially be loosely bolted to the A-arm mounts 78a, b, 94a, b (see FIGS. 5 and 5A). The lower cross brace 28 with left and right brackets 30a, b may be loosely mounted to the roll cage 24 (see FIG. 1). The left and right upper frame members 40a, b may now be slid into left and right tubes 38a, b with bolt 34 attaching left and right upper frame members 40a, b to the left and right tubes 38a, b. (See FIG. 2). The bolt 34 may remain loose to loosely attach the upper left and right frame members 40a, b to the left and right tubes 38a, b. The bolts are not tightened at this time. Due to the slack in the system, the upper left and right frame members 40a, b may also be slid into lower left and right tubes 66a, b. (See FIG. 3). The bolt 34b may be used to secure the upper left and right frame members 40a, b to the lower left and right tubes 66a, b. At this time, the bolts 34a, b are not tightened. Once the rack 12 is loosely mounted to the ATV 10, the bolts 34a, b and 84 are tightened to secure the rack 12 to the ATV 10 and prevent inadvertent loosening or disassembly during use due to vibration and other causes. After the bolts are tightened, the rack 12 still allows movement to mitigate stress concentrations and failure due to bending, twisting, etc. since the holes 42, 74 are oversized with respect to the bolts 34a, b (see FIGS. 2 and 3).

Referring now to FIG. 6, the rack 12 may have a plurality of mounting holes 96a, b, c, d. These mounting holes 96a-d may be used to selectively mount a tire carrier 14 (see FIGS. 5 and 6), a fluid container carrier 16, 18 (see FIGS. 7 and 9), one or more trays 20, 22 (see FIGS. 7 and 8), a stretcher 23 (see FIG. 10) and other components to the rack 12. Each of the mounting holes 96a-d may have two or more mounts 98. The mounts 98 may be equidistantly spaced apart so that the components may be selectively positioned to one or more of the mounting holes 96a-d. By way of example and not limitation, the mounts 98 may be spaced ten inches (10″) apart center to center. In this manner, a component may be mounted to any one of the mounting holes 96a, b, c, d as desired. A close up of the mount 98 is shown in FIGS. 2 and 3. Each of the mounts 98 may form a through hole 100 (see FIG. 2) through the upper left and right frame members 40a, b and/or the rear bumper 62. Each of the mounts 98 may also define a flat vertical surface 102 disposed on opposed sides of the upper left and right frame members 40a, b and the rear bumper 62. When a plate or other bracket is mounted to a mount 98, the flat vertical surface 102 and the orientation of the through hole 100 align the bracket or plate to the vertical orientation. Referring back to FIG. 6, the tire carrier 14 may have a C-shaped channel 104. The C-shaped channel 104 may be bolted to the mounts 98 by inserting a bolt 106 through holes 108 formed in the C-shaped channel 104 and the through holes 100 of the mounts 98. Preferably, two or three bolts are used. A nut and washer 110, 112 is used to tighten the bolt 106 so as to attach the C-shaped channel 104 and the tire carrier 14 to the mounting holes 96a-d. The flat vertical surface 102 (see FIG. 2) of the mounts 98 and the orientation of the holes 100 aid in orienting the tire carrier 14 in the vertical orientation. The tire carrier 14 may be mounted to the left and right sides of the rack 12 as shown in FIG. 6. Additionally, the tire carrier 14 may be mounted to the right side of the rear bumper 62 is shown in FIG. 5. It is also contemplated that the tire carrier 14 may also be mounted to the left side of the rear bumper 62. Some of the benefits of mounting the tire carrier 14 to the sides instead of the rear is that the two tires may be disposed in front of the rear axle to maintain the center of gravity in a forward position, it may increase the roll cage strength and allows for more clearance at the rear of the vehicle 10.

Referring now to FIG. 9, the tire carrier 14 may be used to hold a tire 114. The tire 114 may rest upon a platform 116. A central hole 118 of the hub 120 of the tire 114 may be aligned to a slotted hole 122 formed within a back support 124 of the tire carrier 14. A nut 126 may slide up and down the slotted hole 122 such that the tire carrier 14 may receive a range of tire sizes. When the tire 114 is rested on the platform 116, the backside of the tire 114 rests upon the back support 124. An elastomeric or urethane cross shaped member 128 is sized and configured to receive the hub 120 of the tire 114. A bolt 130 is inserted into a hole 132 of the cross shaped member 128 and engaged to the nut 126. The nut 126 is raised or lowered to align the nut 126 to the central hole 118 of the hub 120. The user turns the bolt 130 via handle 133 compressing the cross shaped member 128 and tightening the tire 114 onto the tire carrier 14. If the tire 114 is mounted to the sides, then the tires 114 may be disposed inward of the maximum width of the vehicle 10 due to the inboard position of the upper left and right frame members 40a, b.

Still referring to FIG. 9, the tire carrier 14 may alternatively hold a fluid container carrier 18. The fluid container carrier 18 may have a box configuration and be mounted to the tire carrier 14 via bolt 134 (see FIG. 9). A fluid container 136 may be inserted into the fluid container carrier 18 and held down by straps 138. The straps 138 may be fed through handle holes 140 and secured to a latch 141. One or more of the tire carriers 14 may be mounted to one or more of the mounting holes 96a-d shown in FIG. 6 for carrying a tire 114 or fluid container 136.

Referring now to FIG. 7, in addition to the tire carrier 14 shown in FIG. 6, additional components may be mounted to the rack 12. By way of example and not limitation, a tray 20 may be mounted to the mounting holes 96a, b (see FIG. 6). The tray 20 may be gapped above the bed 142 of the ATV 10. As such, supplies may be loaded into the tray 20 and also loaded under the tray 20 on the bed 142. The tray 20 may be bolted to two or mounts 98 of the mounting holes 96a, b.

Side tray 22 may be mounted to the mounting holes 96a, b and provide an area above the tire well 144 (see FIG. 8) for storage. Referring now to FIGS. 7 and 8, side trays 22 may be attached to the mounting holes 96a, b via a nut and bolt connection. The side trays 22 may have a back plate 146 (see FIG. 8) with two holes 148. The two holes 148 may be aligned to two adjacent mounts 98. Bolts 150 may be used to bolt the side tray 22 to the mounts 98 with a nut and washer 151, 154. The holes 148 of the side trays 22 may be aligned to other adjacent mounts 98 of the mounting holes 96a, b, c, d as desired.

Referring to FIGS. 7 and 7A, one or more fluid containers 136 may be secured to the bed 142 of the ATV 10 by way of fluid container carrier 18. In particular, the fluid containers 136 may have handle holes 140. Left and right brackets 152a, b may be attached to the mounting holes 96a, b (see FIG. 6). The brackets 152a, b may have an identical pattern. Moreover, the brackets 152a, b may have latching holes 155a, b. An enlarged view of the bracket 152a is shown in FIG. 7A. The brackets 152a, b may be attached to the mounting holes 96a, b via a nut and bolt connection (see FIG. 8). The latching holes 155a, b may be sized and configured to receive an elongate rod 156 (see FIG. 7). The elongate rod 156 may be fed through the latching hole 155a, the handle holes 140 of the fluid containers 136 and the latching hole 155b. The elongate rod 156 maintains the fluid containers 136 within the bed 142 of the ATV 10 during field use and while the ATV 10 is traversing uneven terrain. To lock the elongate rod 156 in the latching holes 155a, b, the elongate rod 156 may have a stop plate 158 on an end thereof. The user grabs the handle 157 inserts the rod 156 into the latching hole 155a, handle holes 140 and the latching hole 155b until the stop plate 158 contacts the bracket 152a, or vice versa until the stop plate 158 contacts the bracket 152b. Once the stop plate 158 contacts the bracket 152a or 152b, a cotter pin 160 may be inserted into a hole 161 formed in the elongate rod 156, as shown in FIG. 7A. The stop plate 158 and the cotter pin 160 sandwich the bracket 152a such that the elongate rod 156 does not become dislodged during use or vibration. It is also contemplated that the elongate rod 156 may be inserted in reverse order. In particular, the elongate rod 156 may be inserted into the latching hole 155b, the handle holes 140 and the latching hole 155a.

Referring now to FIG. 10, a stretcher 23 may be attached to the rack 12. C-channels 162a, b may be mounted to the mounting holes 96a, b. The C-channels may have a strap 164 that can be used to tie down the stretcher 23 onto the C-channels 162a, b. The C-channels may be attached to the mounting holes 96a, b via a nut and bolt connection.

The rack 12 as shown in FIG. 1 may have one or more tie downs 58 permanently attached to the upper left and right frame members 40a, b. Tie downs 58 may be attached to opposed end portions of the rear bumper 62 (see FIG. 3). Also, tie downs 58 may be attached to the left and right brackets 30a, b. Additionally, one or more of the components may have additional tie downs 58a. By way of example and not limitation, tray 20 shown in FIG. 7 may have tie downs 58a which can support a rope, hook, straps, etc. for tying down objects within the tray 20 and in the bed 142. Additionally, ropes, straps, hooks may be hooked to holes 58b (see FIG. 8) for tying down objects within the bed 142 or the tray 20.

It is also contemplated that a rear heat shield pan may be attached to the lower frame 64. In particular, mounts 98 may be formed on the down tubes 80a, b. The rear heat shield pan may be bolted to the mounts 98. Additionally, it is contemplated that the rack 12 and the mounting structures may be powder coated.

Referring now to FIG. 2, the right shoulder harness 32b is attached to the right bracket 30b. Although not shown in FIG. 2, the left shoulder harness 32a may be attached to the left bracket 30a and may have the same structure as described in relation to the right shoulder harness 32b. The right shoulder harness 32b may be attached to a rigid clasp 166. The rigid clasp 166 may have an aperture 168 through which a harness 170 is attached. The harness 170b which is shown in FIGS. 2 and 11 is adjustable so that the harness 170b can be lengthened or shortened based on the size of the occupant in the passenger seat 172 or the driver seat 174. The harness 170b may include a common strap 176 that can be adjusted in length by way of the adjusting buckle 178. Left and right shoulder straps 180 and 182 extend from the common strap 176. Referring now to FIG. 12, a front view of the seat belt harness, backrest 184 and headrest 186 are shown. The left and right shoulder straps 180 and 182 come over the left and right shoulders of the occupant and are releaseably engageable to common buckle 188. Left and right lap straps 192, 194 attached to a chassis of the ATV 10 is also releasably engageable to the common buckle 188. This forms the four point seat belt harness. Optionally, a lower middle strap 190 is also releaseably engageable to the common buckle 188 so as to form a five point seat belt harness. Based on the foregoing discussion, the left and right shoulder harnesses 32a, b allows adaptation of a three point seat belt harness in an ATV to be converted to have a four or five point seat belt harness.

The above description is given by way of example, and not limitation. Given the above disclosure, one skilled in the art could devise variations that are within the scope and spirit of the invention disclosed herein, including various ways of configuring the tie downs. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A rack mountable to an all terrain vehicle having a chassis and a roll cage, the rack comprising:
left and right upper brackets attached to the roll cage;
left and right upper frame members with upper distal end portions moveably attachable to the left and right upper brackets for mitigating failure of the attachment between the upper distal end portions of the left and right upper frame members and the left and right upper brackets; and
left and right lower frame members with upper distal end portions moveably attachable to the lower distal end portions of the left and right upper frame members for mitigating failure of the attachment between the lower distal end portions of the left and right upper frame members and the upper distal end portions of the left and right lower frame members, and lower distal end portions of the left and right lower frame members attached to the chassis.

2. The rack of claim 1 wherein the chassis defines upper and lower A arm mounts of the all terrain vehicle, and the left and right lower frame members are attached to one or both of the upper and lower A arm mounts.

3. The rack of claim 1 wherein one of the distal end portions of the left and right upper frame members and the left and right upper brackets are slideably disposable within the other one of the distal end portions of the left and right upper frame members and the left and right upper brackets for mitigating failure.

4. The rack of claim 3 wherein the left and right upper brackets are tubes and the distal end portions of the left and right upper frame members are tubes that slide within the tubes of the left and right upper brackets for mitigating failure, and the rack further comprises pins that engage both the tubes of the distal end portions of the left and right upper frame members and the tubes of the left and right upper brackets for preventing pull out of the left and right upper frame members from the left and right upper brackets.

5. The rack of claim 4 wherein the tubes of the left and right upper brackets and the tubes of the distal end portions of the left and right upper frame members have corresponding holes sized and configured to receive the pins, the holes formed in the tubes of the distal end portions of the left and right upper frame members are oversized compared to the pin to permit movement and mitigate failure.

6. The rack of claim 1 wherein one of the lower distal end portions of the left and right upper frame members and the upper distal end portions of the left and right lower brackets are slideably disposable within the other one of the distal end portions of the left and right upper frame members and the upper distal end portions of the left and right lower brackets for mitigating failure.

7. The rack of claim 3 wherein the upper distal end portions of the left and right lower frame members are tubes that slide within tubes of the lower distal end portions of the left and right upper frame members for mitigating failure, and the rack further comprises pins that engage both the tubes of the lower distal end portions of the left and right upper frame members and the tubes of the left and right lower frame members for preventing pull out of the left and right upper frame members from the left and right lower frame members.

8. The rack of claim 7 wherein the tubes of the upper distal end portions of the left and right lower frame members and the tubes of the lower distal end portions of the left and right upper frame members have holes for receiving the pins, the holes formed in the upper distal end portions of the left and right lower frame members are oversized compared to the pin to permit movement and mitigate failure.

9. The rack of claim 1 further comprising a rear bumper attached to the left and right lower frame members.

10. The rack of claim 9 wherein the left and right upper frame members and the rear bumper include one or more standard mounting holes to allow a component to be selectively mounted to sides and rear of the rack.

11. The rack of claim 1 wherein the attachments are bolted together for facilitating field repair and replacement.

12. The rack of claim 10 wherein the mounting component is a means for carrying a tire on the rack, a means for carrying a fluid container on the rack, a means for carrying a stretcher on the rack or a tray.

13. The rack of claim 10 further comprising one or more tie downs attached to the left and right upper frame members, left and right lower frame members and/or the rear bumper.

14. The rack of claim 1 wherein the left and right lower frame members are attached to each other by a rear bumper and a cross bar for forming a generally rigid lower frame attached to separate left and right upper frame members.

15. An adaptable rear mounted rack system for an all terrain vehicle having a chassis, the rack system comprising:
a frame defining an upper portion and a lower portion, the upper portion being attachable to a roll cage of the all terrain vehicle and the lower portion being attachable to a rear portion of the chassis of the all terrain vehicle for mounting the frame to the rear of the all terrain vehicle;
a plurality of upper mounts attached to the upper portion of the frame to enable selective attachment of different mounting brackets to the upper portion of the frame for adapting the rack system as needed.

16. The system of claim 15 further comprising a plurality of lower mounts attached to the lower portion of the frame to enable selective attachment of different mounting brackets to the lower portion of the frame for adapting the rack system as needed.

17. The system of claim 16 wherein the mounting bracket is one or more of a tire carrier bracket, a tray bracket, a fluid container carrier bracket and a stretcher bracket.

18. The system of claim 16 wherein each of the upper and lower mounts define a through hole axis generally parallel to each other.

19. The system of claim 18 wherein each of the upper and lower mounts define a flat surface generally perpendicular to the through hole axis.

20. The system of claim 15 wherein the upper portion of the frame defines upper left and right frame members and the lower portion of the frame defines a rear bumper with the upper and lower mounts attached to the upper left and right frame members and the rear bumper.

21. The system of claim 15 wherein the lower portion of the frame is attachable to one or both of upper and lower A-arm mounts of the chassis of the all terrain vehicle.

22. The system of claim 15 wherein the lower portion of the frame is attachable to a rear section of the chassis of the all terrain vehicle.

23. A method of mounting a rack to an all terrain vehicle so that the rack is moutable to the all terrain vehicle by one person, the method comprising the steps of:
loosely attaching left and right brackets to a roll cage of the all terrain vehicle;
loosely attaching left and right upper frame members to the left and right brackets;
loosely attaching left and right lower frame members to at least one of two A-arm mounts of the all terrain vehicle suspension;
loosely attaching the left and right upper frame members to the left and right lower frame members; and
after performing all of the loosely attaching steps, tightening down all of the loose attachments.

24. The method of claim 23 wherein the loosely attaching left and right upper frame members to the left and right brackets step comprises the step of sliding distal end portions of the left and right upper frame members to tubes of the left and right brackets.

25. The method of claim 24 further comprising the step of providing oversized holes in the distal end portions of the left and right upper frame members compared to pins which are used to attach the left and right upper frame members to the left and right brackets.
